(19) United States
(12) Patent Application Publication
(10) Pub. No.: US 2025/0339885 A1
(43) Pub. Date: Nov. 6, 2025

(54) Method for Producing Lightweight Aggregate from Waste Coal Ash and Product Made Therefrom

(71) Applicant: SusMax, Inc.

(72) Inventors: Mohammad Balapour, Philadelphia, PA (US); Yaghoob Farnam, Philadelphia, PA (US)

(21) Appl. No.: 18/751,437

(22) Filed: Jun. 24, 2024

Related U.S. Application Data
(60) Provisional application No. 63/643,054, filed on May 6, 2024.

(51) Int. Cl. B09B 3/00; C04B 18/02

(52) U.S. Cl. CPC B09B 3/00; C04B 18/027

(57) ABSTRACT

An optimized framework to produce lightweight aggregate (LWA) from waste coal ash occupying landfills is provided. The off-spec coal ash used has a high loss of ignition, preventing it from being directly recycled for concrete applications. Leaching tests revealed that sintered LWA had a lower potential of releasing harmful chemicals to the environment in comparison to waste coal ash; long mean residence time and high sintering temperatures promote a large fraction of slag formation, allowing entrapment of heavy metals. The developed LWA met the ASTM required engineered properties, making it suitable for concrete applications. Microstructural analysis showed a core-shell morphology for the LWA and proved the bloating mechanism i.e., pore formation in the slag phase. Formation of sufficient slag phase in the LWA resulted in achieving the desired crushing strength. The invention provides a structured framework for producing LWA from waste coal ash by optimizing the production parameters.

### CROSS-REFERENCE TO RELATED APPLICATION

The present application claims the benefit of U.S. provisional patent application Ser. No. 63/643,054, filed on May 6, 2024, which is incorporated as if fully set forth herein.

### BACKGROUND OF THE INVENTION

### Field of the Invention

The invention relates to a method for producing lightweight aggregate (LWA) from waste coal ash occupying landfills.

### Description of the Related Art

Coal is a major source of energy output around the world; although the utilization of renewable energy is expected to increase over the next few decades, global consumption of coal will also increase from 3840 million tons oil equivalent (MTOE) in 2015 to 4032 MTOE within the next two decades. Burning coal for energy production generates millions of tons of coal ash of which only about 60% is recycled. These ashes are stored in gargantuan amounts in landfills which brings forth numerous environmental issues, such as air contamination, leachates of harmful chemicals to groundwater and soil. Therefore, it is of critical importance that these waste materials should be recycled in a sustainable manner to prevent further environmental impacts.

Balapour et. al developed a systematic thermodynamics-guided framework to design and manufacture waste coal ash into lightweight aggregates (LWA). This framework satisfies the three required conditions for production of LWA: (i) formation of sufficient liquid phase (i.e., 35% or greater to instill pore formation in LWA), (ii) desirable viscosity properties of liquid-solid phase (i.e., low viscosity leads to formation of large pores and vice versa), and (iii) adequate formation of gas phase that can be entrapped by liquid phase for pore formation. Off-spec waste coal ash and other waste ashes (containing calcium, aluminum, and silicate phases) can be used as a raw material to mass produce LWA.

It would be beneficial to be able to produce LWA from waste coal ash at scale.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is an aggregate formed from combustion ash having a loss on ignition between 8 percent and 12 percent, +/−a percentage, wherein the aggregate comprises a concentration of mass of the NaOH per mass of the combustion ash of at least 2%. A method of forming the inventive aggregate is also provided.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a table showing average chemical composition proportion of Ash #1 (±represents standard deviation obtained using the four samples);

FIG. 2 is a table showing average chemical composition proportion of Ash #2 (±represents standard deviation obtained using the four samples);

FIG. 3 is a graph showing a thermodynamic modeling prediction of waste coal fly ash with 0% fluxing agent;

FIG. 4 is a graph showing a thermodynamic modeling prediction of waste coal fly ash with 2% fluxing agent;

FIG. 5 is a sample of aggregate production using Ash #1;

FIG. 6 is a chart showing thermodynamic modeling predictions of fly ash with 0% fluxing agent;

FIG. 7 is a chart showing thermodynamic modeling predictions of fly ash with 2% addition of fluxing agent;

FIG. 8 is a chart showing thermodynamic modeling predictions of fly ash with 4% addition of fluxing agent;

FIG. 9 is a sample of aggregate production from Ash #2;

FIG. 10 is a setup for image analysis showing a reference line and a dynamic angle of repose;

FIG. 11 is a graph showing a comparison of experimental and analytical MRT at different kiln configurations;

FIG. 12 is a is a chart showing experimental and analytical MRT of SPORA sintering at different kiln configurations using different equations;

FIG. 13 is a chart showing oven-dry specific gravity values of fine and SPORA produced during trial phases at different kiln configurations and compared to relevant properties of other commercial aggregates;

FIG. 14 is a chart showing oven-dry specific gravity values of coarse SPORA produced during trial phases at different kiln configurations and compared to relevant properties of other commercial aggregates

FIG. 15 is a chart showing 72-hour absorption capacity of fine LWA LWA SPORA produced during trial phases ad different kiln configurations and compared to the relevant properties of other commercial aggregates;

FIG. 16 is a chart showing 72-hour absorption capacity of coarse LWA LWA SPORA produced during trial phases ad different kiln configurations and compared to the relevant properties of other commercial aggregate;

FIG. 17 is a graph showing crushing strength of SPORA produced at different MRTs compared to other commercially available lightweight aggregates;

FIG. 18 is a graph showing leaching concentrations of selenium at targeted pH values;

FIG. 19 is a graph showing leaching concentrations of astatine at targeted pH values;

FIG. 20 is a graph showing leaching concentrations of barium at targeted pH values;

FIG. 21 is a graph showing leaching concentrations of lead at targeted pH values;

FIG. 22 is a table showing maximum leaching constituents of potential concern (COPC);

FIG. 23 is a table showing production parameters tested to obtain optimized conditions of manufacturing at 1075° C. sintering temperature;

FIG. 24 is a table showing production parameters tested to obtain optimized conditions of manufacturing at 1150° C. sintering temperature;

FIG. 25 is a table showing steps applied for batch pilot scale production using two different sources of coal ash;

FIG. 26 is a final SPORA aggregate;

FIG. 27 is a fractured concrete specimen made using SPORA;

FIG. 28 is a is a table showing comparison of different engineered properties of large scale manufactured SPROA and other commercially available lightweight aggregates;

FIG. 29 is a back scattered electron image of the lightweight aggregates made with Ash #1 using 2% NaOH, sintered at 1075° C. and kiln configuration of 20 and 3 rpm;

FIG. 30 is a SEM Micrograph exhibiting the pore structure of the lightweight aggregates made with Ash #1 using 2% NaOH, sintered at 1075° C. and kiln configuration of 20 and 3 rpm;

FIG. 31 is a SEM micrograph of the pore structure of the lightweight aggregates made with Ash #2 using 4% NaOH, sintered at 1150° C. and kiln configuration of 40 and 5 rpm;

FIG. 32 is a SEM micrograph of the pore structure of the lightweight aggregates made with Ash #2 using 3% NaOH, sintered at 1075° C. and kiln configuration of 40 and 3 rpm;

FIG. 33 is a SEM Micrograph the core morphology and (b) shell formation of the aggregate produced using Ash #1;

FIG. 34 is a SEM Micrograph showing shell formation of the aggregate produced using Ash #2;

FIG. 35 is a SEM Micrograph showing the core morphology of the aggregate produced using Ash #2; and

FIG. 36 is a SEM Micrograph showing the shell formation of the aggregate produced using Ash #2.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The patent starts with optimizing the manufacturing of LWA production in the lab scale (Phase I), and next scaling that manufacturing method and its associated parameter to tonnage scale (Phase II).

Phase-I of this project involved the establishment of lab scale approach for a semi-automated Spherical Porous Aggregate (SPORA) production. A total of ˜3 kg of SPORA production was achieved every 24 hours, where aggregates demonstrated optimal engineered properties.

In Phase II, overall, more than 450 kg (approximately half-a-ton) of suitable engineered SPORA aggregates were manufactured using large-batch scale equipment including screener, mixer, pelletizer, and rotary kiln. It was found that the optimized production parameters in the lab scale can be adopted and used for larger scale production. Optimization in the lab-scale was essential to establish working parameters (i.e., fluxing agent, binder amount, mean residence time of sintering, sintering temperature, etc.) for large-batch production; it is also anticipated that these parameters can be further adopted for continuous tonnage scale production, which will be demonstrated in the future.

In April-May 2024, U.S. Environmental Protection Agency (EPA) announced a set of rulings to curb environmental pollution from coal ash surface impoundments. The regulations aim to ensure safe and sustainable management of coal ash, particularly in areas not regulated by the federal government. EPA's 2024 new ruling affects approximately 290 inactive coal ash landfills. There's an urgency for promising new technologies that can recycle low quality coal ash for closure of these landfills. Therefore, the present invention provides a structured framework to utilize the waste coal ash for LWA production using a proprietary sintering method. We demonstrate how the production parameters that affect the engineering properties of the final product i.e., LWA, were determined in lab scale and were adopted for large scale production, followed by a characterization of engineering properties of the LWA, measuring the leachability of heavy metals from the LWA, and characterizing pore formation and structure of LWA through micrographs.

### 2. Materials Used for Phase I (Lab Scale Production) and Phase II (Half-a-Ton Scale Production)

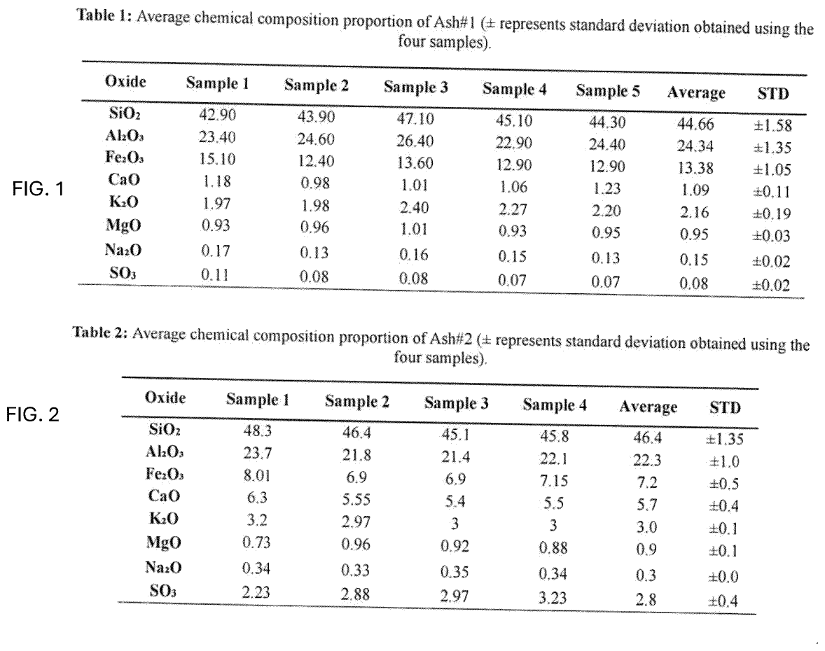

For Phase I and II, two different sources of waste coal combustion ash, such as fly ash, were used for aggregate production, named Ash #1 and Ash #2. Five specimens were selected for X-Ray Fluorescence (XRF) testing on Ash #1 and four XRF testing were performed on the acquired Ash #2 to make sure of the relative consistency (standard deviation of ±5% in major chemical oxides) of the off-spec coal ash chemical composition required for successful SPORA production; Table 1 and Table 2 (FIGS. 1 and 2, respectively) each outlines the chemical composition of Ash #1 and Ash #2. Both types of ash exhibited loss of ignition (LOI) values between 0% and 20%, and in an exemplary embodiment, between 8 and 12% (i.e., 11.18±1.12% for Ash #1, 8.63%±0.81% for Ash #2).

Optimization of production parameters in the lab scale based on thermodynamics modelling and experimental productions.

### 3.1. Thermodynamic Modeling for Sintering

This proprietary technology encompasses a thermochemical analysis guided by thermodynamic modeling using FactSage® software to determine: (i) formation of a sufficient amount of liquid (molten) phase during sintering, (ii) reaching an appropriate viscosity for the solid-liquid phase, and (iii) estimating the gas release potential from the ash using experimental analysis.

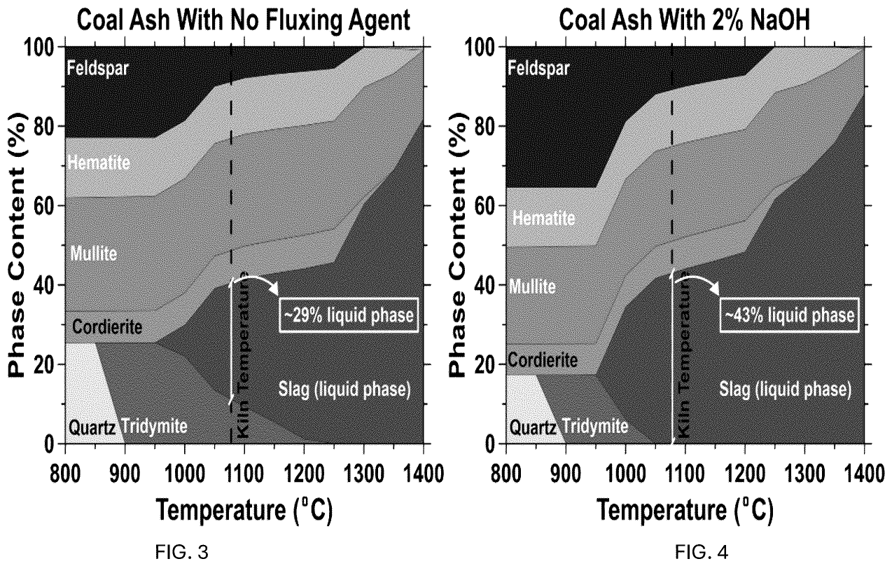

FIGS. 3 and 4 show the analytical modeling results for optimization of fluxing agent content. Ash #1 with 0% fluxing agent, demonstrated 29% of slag/liquid phase at 1075° C. (i.e., the minimum sintering temperature), which was 6% below the required amount (i.e., 35%). On the contrary, when the fluxing agent was increased to 2%, it augmented the formation of slag/liquid phase up to 43%, which was 8% more than the minimum requirement of slag phase. 2% was selected for SPORA preparation using Ash #1.

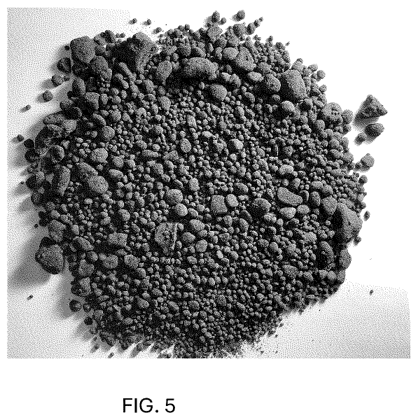

FIGS. 3 and 4 are thermodynamic modeling predictions of waste coal coal ash with 0% fluxing agent, and with 2% fluxing agent, respectively. The white/dashed line illustrates the kiln operating temperature). FIG. 5 shows resulting lab-scale aggregate production using Ash #1.

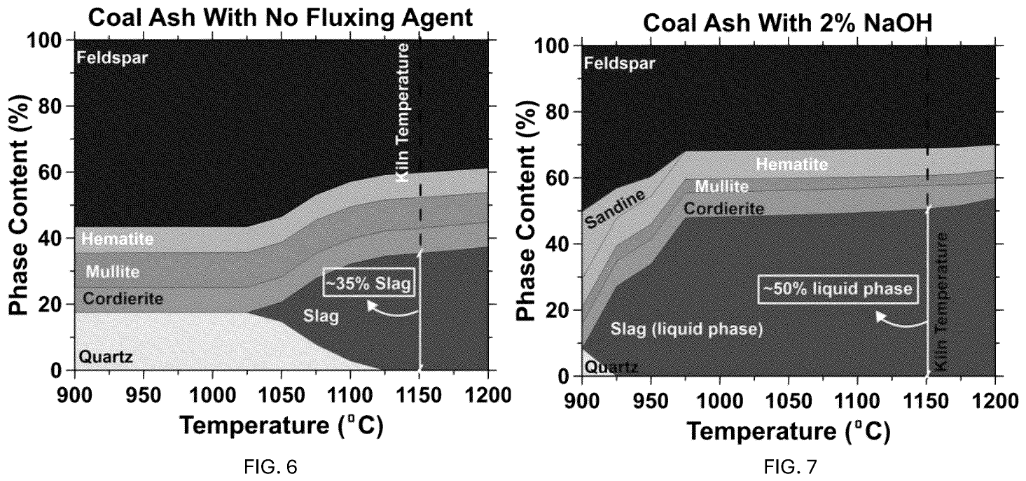

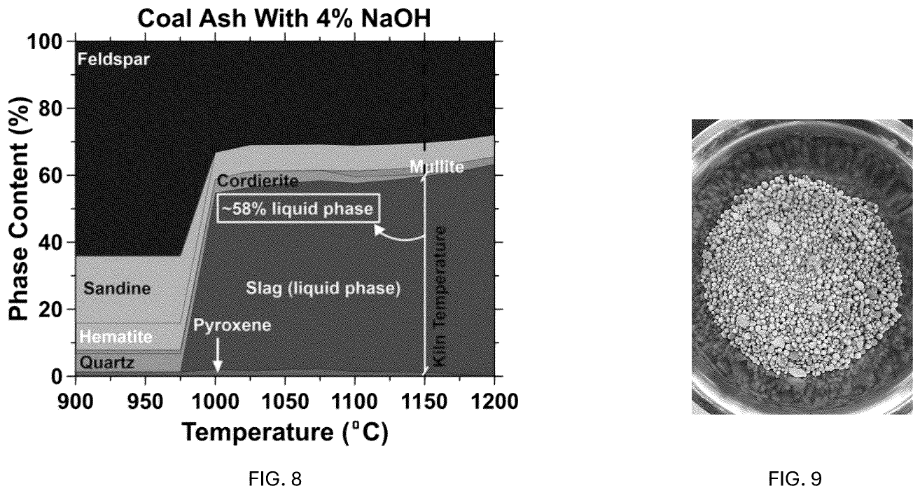

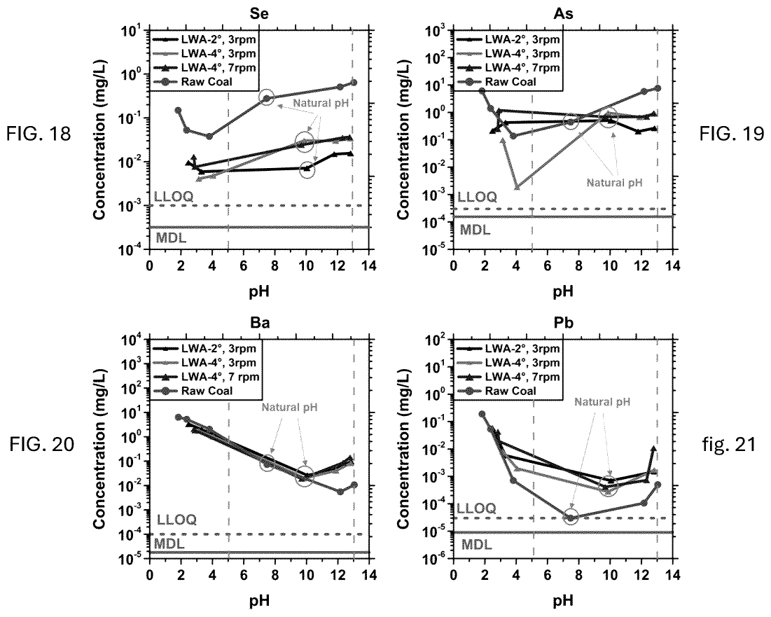

FIGS. 6-8 show the first and the main step of our design process for the Ash #2; FIG. 6 shows the phase diagram of the ash at elevated temperatures with no fluxing agent. FIGS. 7 and 8 show the same ash with the addition of 2% and 4% NaOH as our fluxing agent, respectively. The thermodynamics modeling revealed the coal ash with no fluxing agent will have ˜35% liquid (molten) phase at the kiln operating temperature i.e., 1150° C. The liquid phase at 1075° C. (the kiln operating temperature for production of LWA from Ash #1) was approximately 8%, considerably below the required slag phase for bloating mechanism leading. Addition of 2% fluxing agent led to formation of about 50% slag phase in the LWA. However, as it will be presented in the following sections, it was observed that 24-hour water absorption of the LWA was about 35% which was high and not desirable for internal curing and preparing structural concrete applications. Therefore, the NaOH % was increased to 4% to promote formation of more slag phase and reduce the water absorption of the LWA. The addition of 4% fluxing agent can promote formation of a 58% liquid (molten) phase at 1150° C., essential for a successful bloating mechanism. 4% fluxing agent content was used for the manufacturing of SPORA from Ash #2 discussed in the next section. Experimental analysis presented in the following shows that 4% NaOH results in a well-bonded microstructure for the LWA with ˜25% water absorption capacity, deeming it suitable for concrete applications. FIGS. 18-21 show the collection of aggregates produced from Ash #2.

### Experimental Optimization of Production Parameters of Lightweight Aggregates in Lab-Scale

Building upon the thermodynamic modeling, the optimized parameters were used for initial batch mixing, and production of aggregates were performed semi-manually. The first step of the process was to dry the collected waste coal ash and remove moisture; coal Ash #1 was oven dried at 150±5° C. for 24 hours to remove existing moisture content from ˜25% to 2˜3%. Second, using mesh #30 (600 μm nominal sieve opening) screening was applied to ensure filtration of large particles from Ash #1. Larger particles were about 5% to 8% of the as-received coal ash. Note that Ash #2 did not need drying or screening. Next, oven dried coal ash (i.e., Ash #1) were mixed mechanically with 2% w/w. NaOH solution to form a paste. Afterwards, the fresh coal ash paste was transferred to a pelletizer set at 45° angle for optimal pelletization. 10-20 revolutions per minute (rpm) for a period of 8 to 10 minutes was set to allow adequate pellet formation and achieve uniform spherical shapes. In addition, oven dried coal ash particles were added to the pellets during the pelletization for surface coating which prevented agglomeration during the sintering process. This step of the process is patented and is discussed elsewhere. Next, pellets were oven dried at 150±5° C. for 1.5 hours to remove excess moisture. Afterwards, spherical pellets (i.e., green texture) were placed into a feeder. Dischargement of pellets from feeder to conveyer belt happened at a rate of 5 to 7 grams per minute. The feeding rate was adjusted from time to time if necessary. The conveyor belt transported the green pellets to a shooter, which then was directed towards the rotary surface. The pellets traverse the tube for a specific mean residence time (MRT), dictated by the kiln's angle, rotation speed, and pellets size distribution while sintering occurs at a temperature of 1075° C. (further discussion about MRT optimization is provided in the following section). Positioned at the furnace's elevated end, an exhaust hood captures any gaseous fumes produced during sintering, which tend to escape through the furnace's feeding end due to the drag effect. After sintering, the pellets emerge as Lightweight Aggregate (LWA) named SPORA at the collection point.

The mean residence time (MRT) is the average time a green pellet resides in the tube of rotary furnace. Rotary kiln angle and rotation speed play a critical role in MRT experienced by aggregates in the sintering process. Studies have shown the MRT affects the engineering properties of LWA; if the MRT is too low, it inhibits the bloating mechanism, which is a fundamental requirement for creating pores with the aggregates. It leads to inadequate strength development and other undesirable properties. On the contrary, if the MRT is too high, it leads to formation of thick shell morphological barrier in the outer peripherical section of the aggregates, which reduces water absorption and desorption properties. Balancing the MRT is key to achieving lightweight aggregates with the desired engineering properties without sacrificing production efficiency. It requires careful optimization and control during the manufacturing process. Consequently, MRT was optimized using experimental evaluation and analytical modelling. After a steady-state flow (i.e., input rate=output rate) of SPORA was established through a rotary kiln. Eq. 1 was used to determine the MRT:

Mean Residence time(MRT)=M_{retained}/m Eq. 1
Where,
   M_{retained}=mass of the material retained in the kiln.
   m=mass flow rate of the solid materials (feeding rate)

To evaluate the experimental measurements of MRT using Eq. 1, analytical models were used, such as U.S. Geological (Eq. 2), Chatterjee (Eq. 3), Sullivan's empirical equation (Eq. 4) and Saeman's numerical equations (Eq. 5, Eq. 6, and Eq. 7), MRT values obtained from equations and experimental characterization were compared in FIG. 11.

Mean Residence time(MRT)=0.23×L/β×n0.9 ×D Eq. 2

Mean Residence time (MRT)=0.126×L³/V×(Θ/β)^{1.054}(V/L³×n)^{0.981}×(L/D)^{1.1} Eq. 3

Mean Residence time (MRT)=1.77×L/D×√θ/β×n Eq. 4

dh(x)/dx=3 tan(θ)/4nn×V×(R²−(h(x)−R)²)^{-1.5}−tan(β)/cos(θ) Eq. 5

m_{retained}=ρ×0∫|R²×(wₓ−sin(wₓ)×cos(wx))dx Eq. 6

wx=arccos(1−h(x)/R) Eq. 7
Where,
   L=length of the furnace tube (120 cm),
   D=diameter of furnace tube (6 cm),
   n=rotational speed of furnace (rpm),
   β=inclination of furnace (rad),
   θ=dynamic angle of repose,
   V=volumetric flow rate (g/l),
   R=rotary tube radius (cm),
   h(x)=rotary tube bed height (cm).

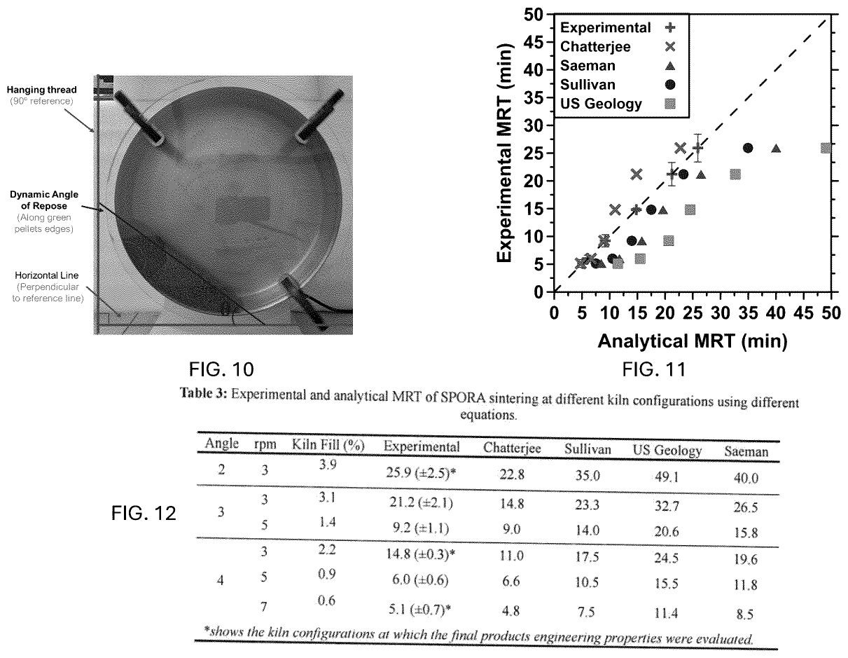

Dynamic angle of repose (DAR) was one of the important parameters in determining MRT before sintering of aggregate. During the lab-scale production, DAR was measured using a video/image analysis method; a rotary drum loaded with fresh SPORA pellets with transparent cover was stationed in the viewpoint of a camera. A 2-minute video/24 images were captured as the drum rotated to determine DAR, as shown in FIG. 10.

Three categories of aggregates were used to achieve an optimal DAR value: fine (smaller than 4.75 mm sieve passing), coarse (larger than 4.75 mm passing) and a 50/50 aggregate blend mix (50% fine and 50% coarse). The DAR value calculated using the method developed by Cheng and Zhao, represented the average between upper and lower boundaries. For fine and coarse SPORA aggregates, the measured DAR values were θ=34.2° and θ=32.5°, respectively. Additionally, the DAR value for the 50%-50% fine/coarse blend was determined to be θ=35.10, which was utilized in MRT calculations.

Table 3 (FIG. 12) shows the MRT values obtained from the analytical models and experimental evaluation. Additionally, FIG. 11 compares the values obtained analytically and experimentally. Using Eq. 8, the average errors of analytical models in comparison to experimental determination were calculated. The average errors for the U.S. Geology, Chatterjee, Sullivan, and Saeman equations were 102. 7%, −11%, 39.4%, and 56.7%, respectively. U.S. Geology equation exhibited the higher error differences, due to the equation limitations (i.e., it does not consider parameters such as dynamic angle of repose that affects the flow behavior). In contrast, the Chatterjee equation proved to be the most effective in adhering to the experimental values. Due to this equation considering parameters such as length, diameter, rotation angle and speed, as well as feeding rate and dynamic angle of repose, it covered all variables and yielded accuracy. In addition, the Chatterjee equation was formulated using a variety of kiln sizes encompassing various length to diameter (L/D) ratios. On the contrary, the Sullivan equation was specifically derived for kilns with an L/D ratio of 14, whereas the L/D ratio determined was 20. Conversely, Saeman's model demonstrates more accuracy for larger kiln dimensions.

Average error %=(predicted MRT−experimental MRT)/experimental MRT×100% Eq. 8

To examine how different sintering conditions affect the engineered properties of SPORA using Ash #1 during lab-scale production, different kiln configurations were evaluated as follows: (2°, 3 rpm), (4°, 3 rpm), and (4°, 7 rpm), corresponding to sintering MRTs of 25.9 minutes, 14.8 minutes, and 5.1 minutes respectively. The evaluated engineering properties encompassed specific gravity, water absorption, and crushing strength of SPORA.

### Specific Gravity and Water Absorption

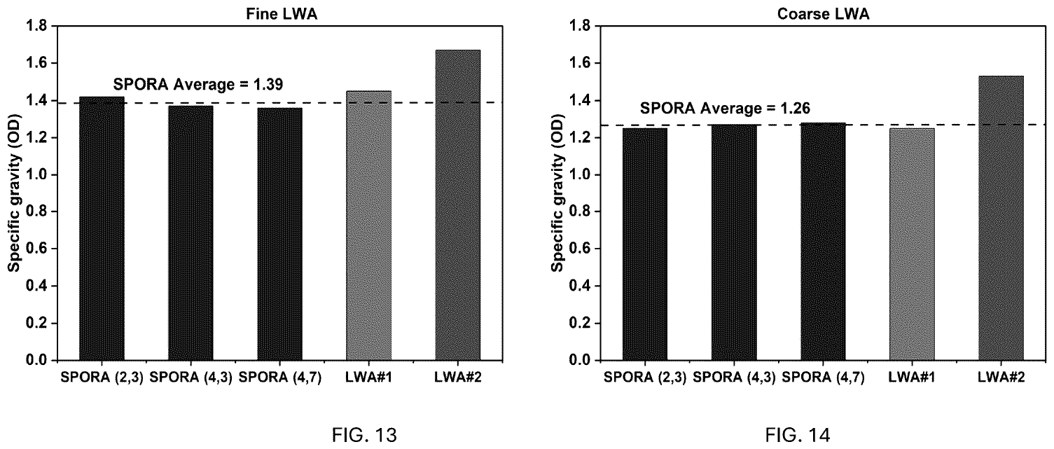

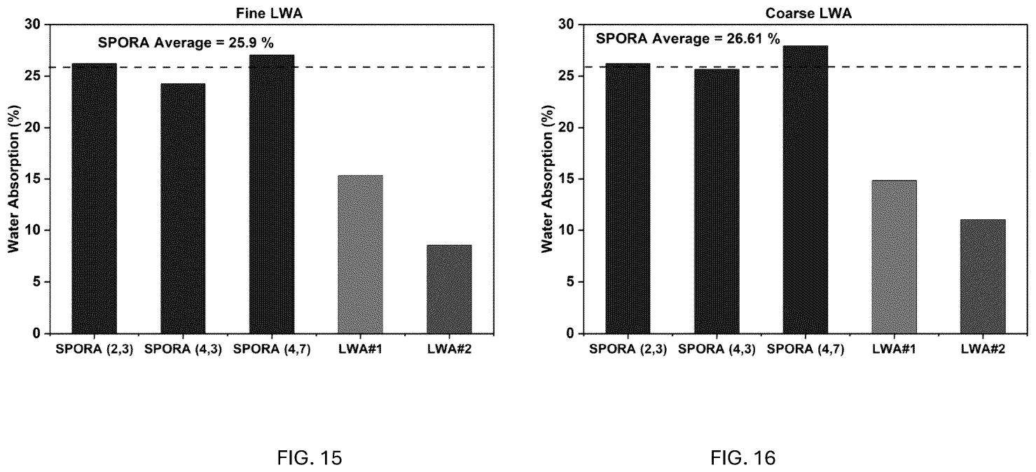

Specific gravity and absorption capacities were measured in accordance with ASTM C127 and C128. FIGS. 13 and 14 show the comparison between the specific gravity values of fine and coarse SPORA, including the pertinent properties of other commercially available aggregates. Fine and coarse SPORA (kiln angle ranging between 2˜4°, 3˜7 rpm) had an average value of 1.39 and 1.26, respectively. These values were comparable to LWA #1, which is a shale-based LWA. However, SPORA's specific gravity was almost 20% lower than that of LWA #2, which is a slate-based LWA. FIGS. 15 and 16 show the 72-hour absorption capacities of aggregates used (i.e., SPORA aggregates produced at different kiln configurations and other commercially available aggregates). The average water absorption capacity of fine and coarse SPORA were 26% and 26.4%, respectively. These water absorption values were 67% and 80%, 200% and 140% higher than that of fine and coarse LWA #1 and fine and coarse LWA #2, respectively. MRT did not meaningfully impact the absorption capacities of different sintered aggregates due to high degree of pore connectivity, as shown in microscopic images in the following sections.

### Crushing Strength of Aggregates

To measure the crushing strength of LWA produced in lab-scale, first the aggregates were sieved to satisfy the following classification ranges, in accordance with EN 1097-1 standard: 4.75 mm to 6.35 mm, 6.35 mm to 9.5 mm, and 9.5 mm to 12.5 mm. A cylindrical mold with a diameter of 73 mm and height of 74 mm was used; LWA samples were placed into the mold and compacted on a vibrational table for 45 seconds, followed by additional LWA placement and compaction to level the top surface for uniform stress distribution. A steel piston with a diameter of 71.25 mm was used to load the LWA in the cylinder. A Tinius Olsen compressive testing machine was used to apply the loading rate of 0.2 mm/s to the piston. The crushing resistance strength was calculated based on the load (P20 mm) that led to 20 mm displacement for LWA in the cylinder and the cross-sectional area of the cylinder (i.e., Eq. 9).

Bulk LWA Crushing Strength (MPa)=P_{20 mm}/A Eq. 9

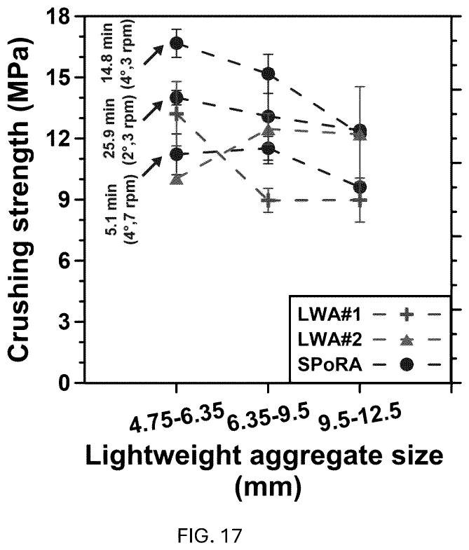

FIG. 17 shows the crushing strength of SPORA produced at different MRTs compared to that of LWA #1 and LWA #2. Specific MRT (i.e., 5.1 min at 4° and 7 rpm), although provides sufficient strength for SPORA but does not provide enough bonding between particles during sintering. Notably, fresh pellets after drying process-maintained strength of approximately 1 MPa. At MRT of 5.1 min observations indicated that when SPORA was soaked in water for testing, the aggregates could easily fall apart during handling. In contrast, such observation was not evident for SPORA produced with an MRT of 14.8 min (4° and 3 rpm) and 25.9 min (2° and 3 rpm). Nevertheless, an MRT of 14.8 min resulted in a higher crushing strength compared to MRT of 25.9 min. This observation implied that sufficient melting should happen during the 14.8 min of sintering and beyond that, rearrangement of pores during sintering affects the crushing strength of SPORA. At MRT of 14.8 min, an average crushing strength of 14.7 MPa was achieved which is about 28% higher than the crushing strength of LWA (11.5 MPa). Specifically, in comparison to LWA #2, SPORA is 20% lighter, while being 28% stronger, and can offer 200% more water absorption. Notably, LWA #2 was found to be the dominant commercial LWA in the US-based market. These properties deem SPORA the more technically viable choice for our customers compared to our competitors' LWA products.

Waste coal ash can be classified as a potential source of deleterious metals (i.e., Sb, As, Ba, Cd, Cr, Co, Pb, and Se) that can leach to the surrounding environment, specifically to river streams and groundwater. Hence, it was critical to evaluate the leaching potential of harmful metals of sintered LWA manufactured from waste coal ash. To assess the leaching properties, Leaching Environmental Assessment Framework (LEAF) 1313 method was utilized; this method analyzes the degree of leaching over a broad range of pH over multiple liquid to solid ratios.

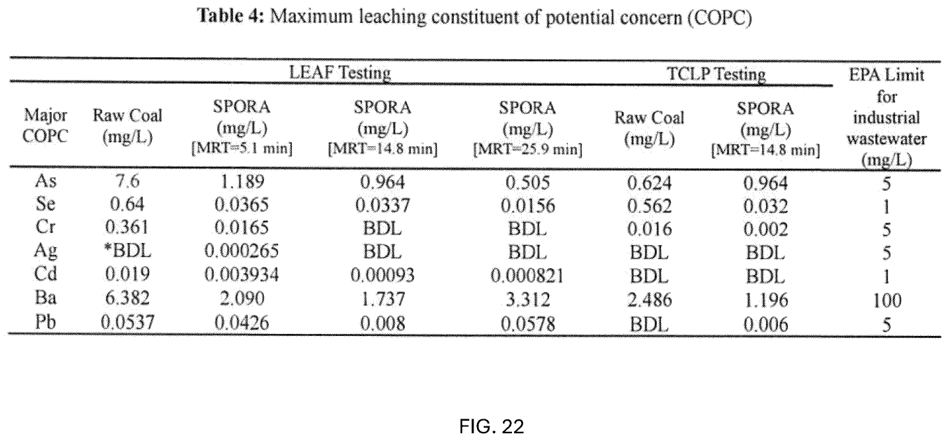

SPORA #1 and Ash #1 specimens were crushed and grounded mechanically to obtain fine powdered particles passing through #50 sieve. Afterward, specimens were placed in glass containers followed by saturation with deionized water and a combination of acid/base solutions to achieve individual pH values, ranging between 2 to 13 and a liquid to solid (L/S) ratio of 10. The acid solution was 2N HNO₃ and base solution was 1N KOH, respectively. Followed by an agitation for 24 hours at 25 rpm, specimens were vacuum filtered with 45 μm filters and pH was measured. FIG. 9 shows the degree of leaching of Se, As, Ba, and Pb from SPORA manufactured through different MRTs and Ash #1 at different pH levels. The dashed orange lines show the realistic pH limit domain between 5 to 13. As evidenced from the plots, the leaching concentration of Se and As increases with increasing pH. Moreover, the potential of leaching from raw coal ash was found to be much higher compared to SPORA. On the contrary, the potential of Ba and Pb leaching from the SPORA, and raw coal ash decreases with increasing pH with one exception: the degree of leaching potential tends to spike at pH 13 for all specimens. In this instance, the susceptibility of Ba and Pb leaching from SPORA was found to be higher than raw coal ash. Nevertheless, the leaching concentrations of Ba were far below the EPA limit for industrial wastewater, as outlined in Table 4 (FIG. 22). Leaching concentration of As from raw coal ash was found to be higher than the EPA limit, whereas the leaching concentration of As from SPORA was substantially lower. Subsequently, leaching of other elements was significantly curbed due to encapsulation of heavy metals during the sintering phase of LWA production.

In summary, SPORA demonstrated a lower degree of leaching potential compared to raw waste coal ash, and the concentration values remain well below EPA limits. Additionally, high MRT can restrict the maximum leaching of contaminants of potential concern (COPC) from SPORA due to encapsulation of heavy metals via formation of liquid phase during the sintering stage. In other words, longer MRT enhances the formation of liquid phase of SPORA, and further facilitating entrapment of heavy metals in the core of aggregates.

In conclusion, using Ash #1 for lab-scale SPORA production optimization of following different parameters was achieved: (i) sample preparation procedure, specifically using 2% NaOH solution as fluxing agent for pellet formation, and (ii) using dry waste coal ash without fluxing agent for coating fresh pellets to prevent agglomeration, and (iii) optimal sintering temperature (guided by thermodynamics modeling) and MRT (14.8 minutes) via adjustment of kiln angle, revolutions per minute of the furnace, and pertinent dimensional and flow rate parameters. Furthermore, it was also found that high MRT allows improved formation of liquid phase at sintering phase (1075° C.), which allows better encapsulation of heavy metals in the LWA and substantially reduces leaching of heavy metals to the environment.

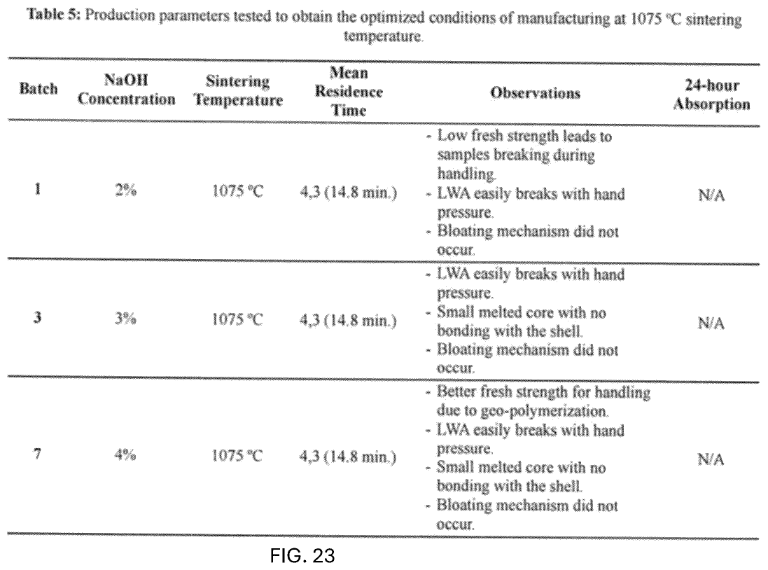

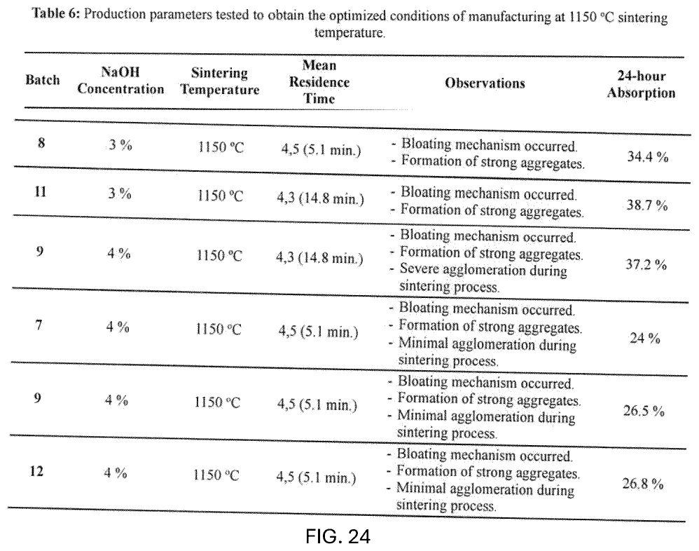

Using the knowledge obtained for SPORA manufacturing using Ash #1, SPORA manufacturing from Ash #2 was optimized. Table 5 and Table 6 (FIGS. 23 and 24, respectively) show production parameters for the produced samples using Ash #2, with the specific NaOH concentration, kiln sintering temperatures (i.e., 1075° C. and 1150° C.), kiln configuration leading to the MRT of sintering, specific observation about the samples and 24 hour water absorption. Using Ash #1, it was found out that water absorption is the parameter most impacted by NaOH concertation, kiln temperature, and to some extent with MRT, and therefore, it was the only engineering properties measured during the optimization. Other engineering properties such as specific gravity and unit weight were not impacted by those variables.

As can be seen on Table 5 (FIG. 23), sintering temperature of 1075° C. was not high enough for slag formation to result in sufficient strength for the SPORA and trigger the bloating mechanism. Therefore, the temperature was increased to 1150° C. as shown in Table 6 (FIG. 24). A 3% NaOH resulted in high water absorption (greater than 33%) which was not desirable. Therefore, the NaOH was increased to 4% to promote formation of more slag phase and reduce the absorption capacity of the SPORA. Batches 7, 9, and 12 demonstrate the repeatability of our manufacturing and the corresponding results for the optimal SPORA samples using Ash #2. For these optimal samples, the following specific gravities were obtained: oven dry specific gravity was 1.3, saturated surface dry specific gravity was 1.65 and apparent specific gravity was 2.

After demonstrating the feasibility of utilizing Ash #1 and Ash #2 for SPORA production at lab-scale, the next step was to scale-up the production by 60 to 80 times. It was critical to demonstrate the repeatability and scalability of the manufacturing process, and achievement of desirable engineered properties of SPORA. In total, approximately ˜250 Kg of LWA using Ash #1 and ˜200 kg of LWA using Ash #2 were produced, in collaboration with an industrial equipment manufacturer based in USA. Manufacturing process was carried out using the guidelines of the proprietary manufacturing method as tested in lab-scale production; the steps were as follows: (1) drying the ash (if needed) (2) screening the ash (if needed) (3) mixing coal ash with fluxing agent (NaOH) and water, (4) Pelletizing the fresh mixtures, (5) drying of fresh pellets, (6) and sintering the pellets using a rotary kiln.

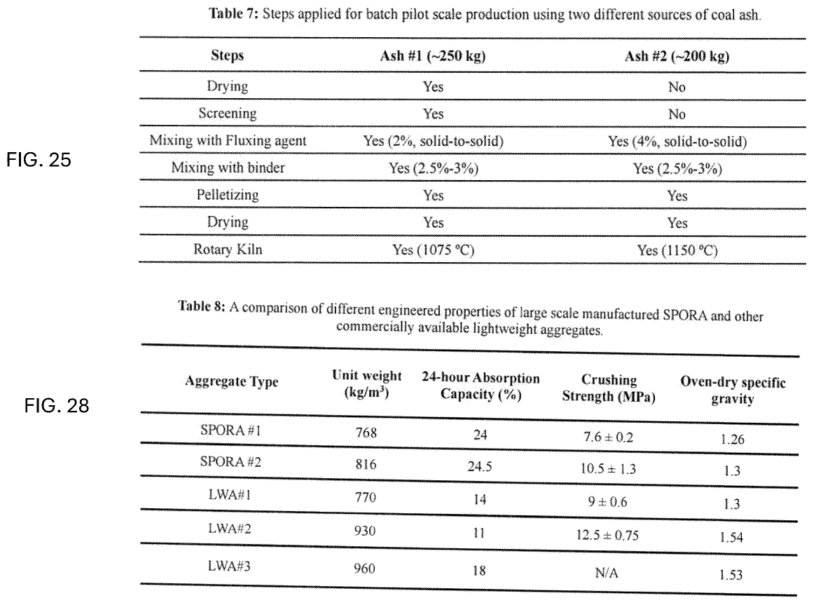

Fresh strength of pellets is a critical concern during commercial production. The concern for fresh pellets not achieving sufficient strength during the handling process was raised during scale up production. This was not evident during the lab-scale production process due to the small scale and delicacy of the production. Therefore, it was concluded that lignosulfonate (i.e., water-based soluble polymers) enhanced the strength of the pellets to extent required for industrial handling using feeders and conveyor belts. Specifically, the pellets passed the drop test that entails dropping fresh pellets from 1 meter high 25 times and observing no visual cracks on their surface. Table 7 (FIG. 25) shows all the steps applied for the pilot batch production using coal ash from two different sources (i.e., Ash #1 and Ash #2).

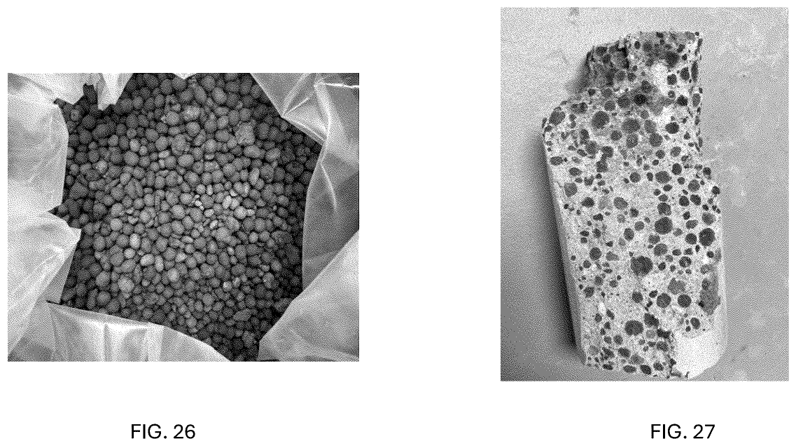

FIGS. 26 and 27 show aggregates produced after sintering (FIG. 26), and fractured concrete specimen prepared using SPORA (FIG. 27). The following parameters, which were obtained in lab scale production, were used for the pilot scale production as follows (i.e., optimized parameters from analytical modeling and experimental evaluation):

### For Ash #1:

Kiln sintering temperature was set at 1075° C.
2% NaOH was used as fluxing agent.
0˜3% lignosulfonate was used as binder agent. (the binder content can be up to 5%, if necessary)
MRT at 1075° C. was kept about −15 minutes.
   and, for Ash #2:
Kiln sintering temperature was set at 1150° C.
4% NaOH was used as fluxing agent.
0˜3% lignosulfonate was used as binder agent. (the binder content could be up to 5% if necessary).
MRT at 1150° C. was kept about 5 to 6 minutes.

According to an exemplary embodiment for manufacturing the inventive aggregate, a mixture of water, fluxing agent, and binder is pumped from a liquid storage tank to a mixer to be mixed with the dried ash that was continuously fed to the mixer. A storage tank is connected to a plurality (i.e. four) nozzles that are located on a pelletizer for controlling the particle size distribution of the fresh pellets by adjusting the moisture. The mixer feeds the moist ash mixture to the pelletizer through the indicated pipe using gravitational force. To ensure proper particle size distribution and conforming to the ASTM C330 standard, the liquid mixture is spray-added to the fresh paste in the pelletizer using nozzles located on the top of the pelletizer. By adjusting the location of the nozzles, the particle size distribution can be adjusted. This enables production of fine aggregates (i.e., particle size<4.75 mm) and coarse aggregates (i.e., particle size>4.75 mm); targeted ˜90% coarse aggregates and ˜10% fine aggregates can be achieved during the production process for SPORA made from Ash #1. A target of ˜70% coarse aggregate and 30% fine aggregate can be achieved for SPORA made from Ash #2. Furthermore, it is noteworthy to control MRT (i.e., total time fresh pellets are exposed to a specified kiln temperature). Adhering to the optimized MRT is necessary to prevent SPORA agglomeration during sintering. The MRT for SPORA made from Ash #1 can be kept at ˜15 minutes, while for SPORA made from Ash #2 can be kept between 5 to 6 minutes. FIG. 26 shows the final product i.e., SPORA after cooling down. FIG. 27 shows the fractured concrete sample made with SPORA. The pilot-scale production proved the scalability of our manufacturing method using the optimized parameters in the lab scale that can be easily adopted for large scale production.

Table 8 (FIG. 28) shows the engineering properties of SPORA produced from Ash #1 and Ash #2 at large scale compared to commercially available LWA in the market. Note that the measured properties are for the coarse SPORA with a particle size of greater than 4.75 mm. Oven dry specific gravities for SPORA #1 (Ash #1) and SPORA #2 (Ash #2) were 1.26 and 1.3, respectively. Furthermore, 24-hour absorption capacities for both types of SPORA aggregates were 24% and 24.5%. The differences in engineered properties between the lab-scale SPORA and large-scale SPORA were found to be minimal. This demonstrated that the lab-scale optimized production parameters must be adopted in large-scale manufacturing of aggregates.

### Microstructural Analysis of Lightweight Aggregates

### Specimen Preparation

Scanning electron microscopic (SEM) analysis was performed on some of the specimens to observe the microstructure and confirm occurrence of the bloating mechanism (i.e., formation of gas filled pores in melted microstructure of LWA). To evaluate the pore structure of SPORA aggregates from different waste coal ash sources and different sintering conditions, single aggregates were dried and placed in containers for submersion in low-viscosity epoxy. Afterwards, the specimen containers were subjected to vacuum conditions for approximately ˜10 minutes; this step was critical to ensure entrapped air bubble removal and successful epoxy resin penetration into the pore structure. Followed by a curing process of 24 hours, the epoxy-fixated specimens were cut at the mid-cross-section of the aggregates using a diamond saw. Next, the cut-surfaces were polished using #400, #600, #800, and #1200 paper to smoothen the surface. Furthermore, specimens were sputter coated using platinum at a 10-15 nm thickness. The microstructures of the samples were observed using a ZEISS SUPRA 50VP SEM.

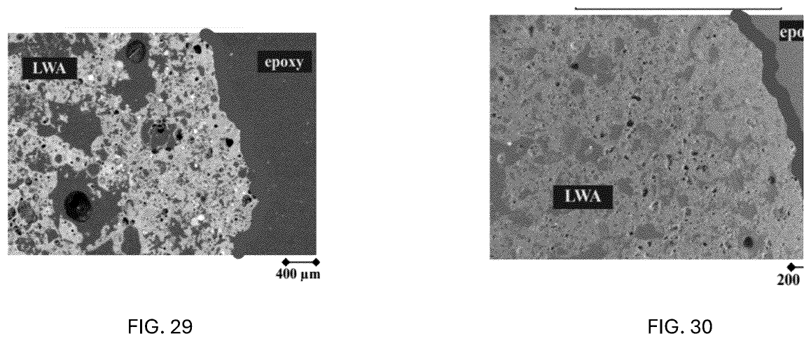

FIGS. 29 and 30 are micrograph and secondary electron image of the LWA sintered using waste coal Ash #1 using 2% NaOH at 1075° C. at kiln configuration of 2° and 3 rpm. The SEM image/micrograph shows a uniform pore distribution (small and large pores), and well-sintered structure. The image shows formation of closed pores (no epoxy impregnation) and connected pores (impregnation of pore network via epoxy resin). In addition, no evidence of irregular deformities (different from the usual pore formations) was observed which could affect the structural integrity of the aggregate.

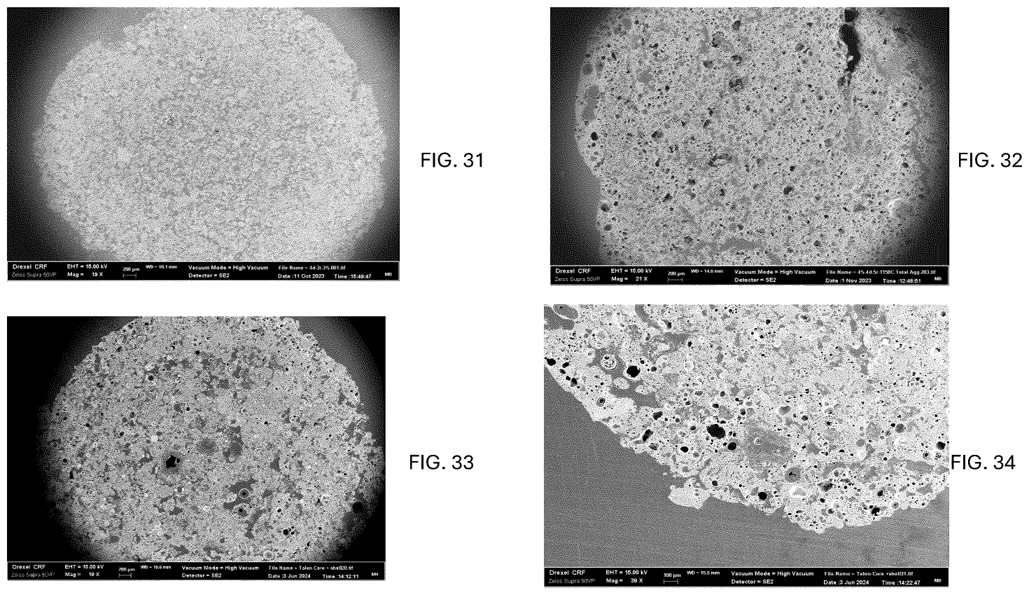

FIG. 31 shows the LWA made with 3% NaOH, sintered at 1075° C. at a kiln configuration of 4° and 3 rpm (MRT=14.8 min); As can be seen, spherical pores were not formed in the microstructure of the aggregate due to lack of slag formation during sintering process, which was also confirmed by thermodynamics modeling. This observation indicates that the bloating mechanism did not occur.

FIG. 32 shows the micrograph of the LWA prepared with 4% NaOH, sintered at 1150° C. with a kiln configuration of 4° and 5 revolutions per minute (MRT=5.1 minutes). Evidently, a nice well sintered microstructure was formed which leads to sustained strength for the aggregate and limited water absorption due to presence of closed pores that cannot be filled with water upon exposure. Furthermore, formation of a comparatively large, disconnected void (evidenced by the dark region) was observed in the microstructure of the aggregate, which we consider a defect can potentially result in lower crushing strength. Additional studies and testing needed to be performed using large-scale aggregates to prove the casualty of defects in achieving reduced crushing strength, if any.

FIG. 33 shows the secondary electron image of the core of an aggregate produced at a large-scale using Ash #1 and optimized parameters. The SEM micrograph shows formation of a spherical shape, with uniform distribution of closed (disconnected pores shown the dark regions on the image as epoxy did not penetrate) and open pores (connected pores shown by grey regions on the image as epoxy resin was able to penetrate the pore structure under vacuum conditions).

FIG. 34 shows the SEM micrograph of the shell region of the aggregate produced from Ash #1. In addition to the formation of closed and open pores, the outer rim of the aggregate appeared to be porous, as evidenced by impregnation of epoxy resin (i.e., grey regions around the peripheral section of the aggregate). This is beneficial for concrete applications as hydrated cement products tend to permeate into the porous regions of the aggregate, resulting in an improved ‘inter-locking’ effect, resulting in improved fractured properties and strength gain.

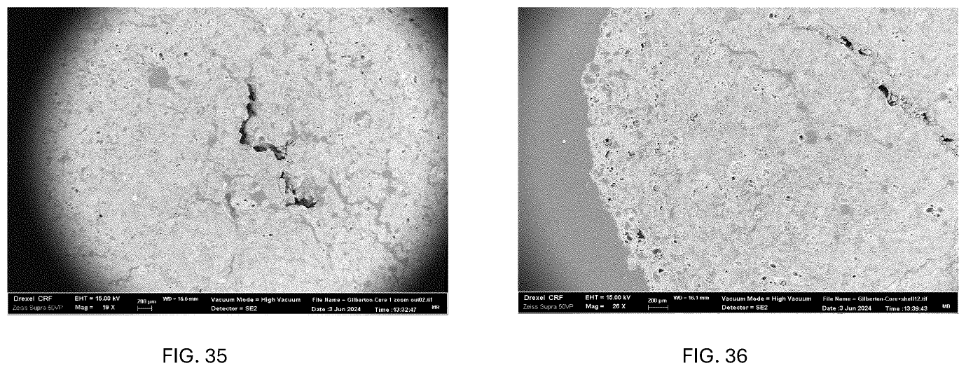

FIG. 35 shows the SEM micrograph of the core structure of the aggregate produced at a large-scale using Ash #2. Similar to Ash #1, uniform distribution of closed and open pores was observed, including formation of a spherical shape. However, in this instance, formation of a large, disconnected void was also found in the core of the aggregate (evidenced by the dark fractured region in the middle), which can contribute to lower intrinsic strength; however, this was not evident during the crushing strength test, as shown in Table 8. In comparison to SPORA #1 (LWA produced using Ash #1), SPORA #2 achieved improved strength values (i.e., 7.6±0.2 MPa for SPORA #1, 10.5±1.3 MPa for SPORA #2). As evidenced by the thermodynamic modeling (i.e., FIGS. 3-9), higher dosage of NaOH (i.e., 4%) promoted larger content of slag formation (58%) for Ash #2, sintering at 1150° C., which resulted in well-bonded microstructure for SPORA #2. Although, the SPORA #2 had small-scale disconnected defects around mid-sections, formation of well-rounded structure and strong shell morphology resulted in higher crushing strength.

FIG. 36 shows the outer perimeter region of the aggregate with presence of a well-rounded structure with porous regions (evidenced by epoxy resin penetration).

The present invention provides the design requirements and optimized parameters of lightweight aggregate (LWA) manufacturing process using waste coal ash. Due to the urgency for sustainable recycling of coal ash (i.e., a by-product of coal combustion), a systematic framework was utilized to convert coal ash into LWA through a proprietary sintering process. Such LWA can be used for constructing lightweight structural elements and improve strength and durability of concrete via internal curing. The following points summarize all the important aspects of this invention:

XRF results of Ash #1 and Ash #2 revealed comparable consistency in the oxide composition of both ashes. Furthermore, both ashes exhibited loss of ignition ranging between 8˜12%, which prevents them from being directly used for concrete applications as supplementary cementitious materials.

Thermodynamic modeling using Factsage® software facilitated the determination of suitable fluxing agent content as mentioned below:

For Ash #1, to achieve a minimum 35% slag phase, 2% NaOH needs to be added at 1075° C. sintering temperature (i.e., 43% slag phase was achieved).

For Ash #2, to achieve a minimum 35% slag phase (and desirable engineering properties), 4% NaOH needs to be added at 1150° C. sintering temperature (i.e., 58% slag phase was achieved).

During development of the present process, it was found that Chatterjee analytical model was comparable to experimental results, due to comprehensive factor considerations by the analytical model, such as length of kiln, diameter, rotation angle, speed of rotation, as well as feeding rate, and DAR.

SPORA #1 exhibited a lower degree of leaching potential in comparison to waste coal ash. The concentration levels assessed using LEAF 1313 method were significantly below the limits set by EPA. Longer MRT hinders the leaching of contaminants (i.e., heavy metals) via formation of slag phase during sintering process, which entraps the deleterious metals in the aggregate's microstructure.

Large-scale aggregates were produced at a half-a-ton scale; further optimization revealed that these both types of ashes require addition of lignosulfonate (2.5˜3%) to promote sufficient strength gain of fresh pellets required for handling of aggregate during commercial production.

Engineered properties of LWA produced in lab-scale and large-scale were evaluated in compliance with the ASTM standards. The obtained engineering properties from lab scale and large scale were closely comparable with each other. Large scale results of SPORA #1 showed that the oven-dry specific gravity of 1.26, absorption capacity of 24%, and crushing strength of 7.6 MPa. Results of SPORA #2 showed the oven-dry specific gravity of ˜1.3, absorption capacity of 24.5%, and crushing strength of 10.0 MPa. These values were comparable to other commercially available LWA manufactured from natural resources such as shale or slate.

Microstructural characterization of SPORA aggregates produced in both lab-scale and large-scale with optimized parameters demonstrated pore formation (open and closed pores) and well-rounded shell formation. Although, SPORA #2 showed some defects (disconnected voids in mid-sections of aggregates), higher percentage of slag formation as a result of higher fluxing agent promoted a well-bonded microstructure, which lead to desirable strength gain in comparison to SPORA #1.

Overall, the present invention provides a structured framework of a scale-up process of producing LWA using waste coal combustion ash, instead of using naturally sourced aggregates. SPORA can be deemed as a sustainable construction product for incorporation in concrete applications such as structural lightweight concrete, internally cured concrete, fire resistant concrete, insulating concrete, masonry concrete blocks, precast concrete, etc.

It will be further understood that various changes in the details, materials, and arrangements of the parts which have been described and illustrated in order to explain the nature of this invention may be made by those skilled in the art without departing from the scope of the invention as expressed in the following claims.

We claim:

1. A method for producing aggregate from coal ash comprising the steps of:
(a) setting a sintering temperature in a kiln to at least 1075° C.;
(b) adding at least 2% by weight of NaOH as a fluxing agent to coal ash to form a mixture;
(c) pelletizing the mixture to form pellets;
(d) adding the pellets to the kiln;
(e) maintaining the ash and fluxing agent in the kiln for a mean residence time of at least 5 minutes, forming an aggregate; and
(f) removing the aggregate from the kiln.

2. The method according to claim 1, further comprising, after step (a) and before step (c), the step of adding at least 2.5% by weight of lignosulfonate.

3. The method according to claim 2, wherein the lignosulfonate is between 0% and 5% by weight.

4. The method according to claim 1, wherein step (e) comprises keeping the mean residence time at approximately 15 minutes.

5. The method according to claim 1, wherein step (a) comprises setting the kiln temperature at 1150° C.

6. The method according to claim 1, wherein step (b) comprises adding 4% by weight of NaOH.

7. The method according to claim 1, wherein step (b) comprises adding coal combustion ash.

8. The method according to claim 1, wherein step (d) comprises adding the mixture to a rotary kiln.

9. The method according to claim 1, wherein step (b) comprises adding fly ash to the kiln.

10. The method according to claim 1, further comprising, prior to step (c), adding water to the kiln.

11. An aggregate produced from coal ash, the aggregate produced by the method of:
(a) setting a sintering temperature in a kiln to at least 1075° C.;
(b) adding at least 2% by weight of NaOH as a fluxing agent to coal ash to form a mixture;
(c) pelletizing the mixture to form pellets;
(d) adding the pellets to the kiln;
(d) maintaining the ash and fluxing agent in the kiln for a mean residence time of at least 5 minutes, forming an aggregate; and
(e) removing the aggregate from the kiln.

12. An aggregate comprising coal ash having a loss on ignition between 0% and 20%, wherein the aggregate comprises a concentration of mass of the NaOH per mass of the combustion ash of at least 2%.

13. The aggregate according to claim 12, wherein a 35% slag phase is formed.

14. The aggregate according to claim 12, wherein the NaOH is added to the coal ash at 1075° C.

15. The aggregate according to claim 12, wherein the concentration of mass of the NaOH per mass of the coal ash is at least 4%.

16. The aggregate according to claim 15, wherein a 58% slag phase is formed.

17. The aggregate according to claim 15, wherein the NaOH is added to the coal ash at 1150° C.

18. The aggregate according to claim 12, further comprising between 0% and 5% by weight of lignosulfonate.

19. The aggregate according to claim 12, wherein the aggregate has a 24 hour absorption capacity of greater than 24%.

20. The aggregate according to claim 12, wherein the aggregate has an oven dry specific gravity of about 1.26.
